(19) United States
(12) Patent Application Publication
(10) Pub. No.: US 2008/0101883 A1
(43) Pub. Date: May 1, 2008

(54) RAIL ATTACHMENT MOUNT

(76) Inventor: Thomas E. Derecktor, Portsmouth, RI (US)

Correspondence Address: PILLSBURY WINTHROP SHAW PITTMAN, LLP, P.O. BOX 10500, MCLEAN, VA, 22102, US

(21) Appl. No.: 11/554,768

(22) Filed: Oct. 31, 2006

(51) Int. Cl. B61D 45/00; E04G 5/06; B60R 9/00

(52) U.S. Cl. 410/104; 224/403; 248/220.21

(57) ABSTRACT

A rail attachment mount and method of use is provided for attaching a mount to a rail. The rail comprises a track with a pair of flanges and the mount comprises a track receiving cavity and a pair of flanges defining an opening to the cavity. A first of the flanges of the track is inserted into the track receiving cavity of the mount through the opening. The mount is pivoted so as to insert a second of the flanges of the track into the track receiving cavity of the mount through the opening and the mount is fastened to the rail such that a tightened, secure attachment is established with the flanges of the mount being forcibly engaged with the flanges of the track.

### FIELD OF THE INVENTION

The present invention relates to a rail attachment mount and, more particularly, to an attachment mount that enables transverse attachment.

### BACKGROUND OF THE INVENTION

Conventional truck bed accessories are typically attached to rail tracks by sliding a slotted mount over an end of a track. The mount and accessory are then slid along the track until they reach their final position. Due to nonconformities in the vehicle, rail, or track, however, sliding mounts may run into problems such as, for example, binding, derailment, or blockage. In cases where accessories have two mounts coupled thereto, each sliding onto opposite rails on a truck bed, a small defect may result in the rails becoming nonparallel and cause the accessory mounts to bind, preventing attachment.

### SUMMARY OF THE INVENTION

In accordance with an embodiment of the present invention a method is provided for attaching a mount to an elongated rail. The rail comprises a track with a pair of flanges and the mount comprises a track receiving cavity and a pair of flanges defining an opening to the cavity. A first of the flanges of the track is inserted into the track receiving cavity of the mount through the opening. The mount is pivoted so as to insert a second of the flanges of the track into the track receiving cavity of the mount through the opening and the mount is fastened to the rail such that a tightened, secure attachment is established with the flanges of the mount being forcibly engaged with the flanges of the track.

In accordance with a further embodiment of the present invention, a rail attachment mount is provided for mounting to a rail member. The rail member comprises a track with a pair of flanges and the mount includes a body having walls defining a track receiving cavity. The mount further includes a pair of flanges defining an opening to the track receiving cavity. The track receiving cavity is configured to receive a first of the flanges of the rail member's track through the opening and to enable pivotal movement of the mount to insert a second of the flanges of the rail member's track into the cavity of the opening. A fastener is constructed to secure the mount onto the track with the flanges of the mount being forcibly engaged with the flanges of the track.

Other objects, features, and advantages of the present invention will become apparent from the following detailed description, the accompanying drawings, and the appended claims.

### BRIEF DESCRIPTION OF THE DRAWINGS

The above-mentioned and other features and advantages of this disclosure, and the manner of attaining them, will become more apparent and the disclosure itself will be better understood by reference to the following description taken in conjunction with the accompanying drawings, wherein:

FIG. 1 is an end view of a rail and rail attachment mount in accordance with an embodiment of the present invention;

FIG. 2 is an exploded schematic diagram of a mount and liner in accordance with an embodiment of the present invention;

FIGS. 3-5 illustrate steps in the attachment process of a rail attachment mount in accordance with an embodiment of the present invention;

FIG. 6 is a perspective view of a clamping rail attachment mount in accordance with other embodiment of the present invention;

FIG. 7 is a side view of a clamping rail attachment mount in an open position in accordance with an embodiment of the present invention;

FIG. 8 is a side view of a clamping rail attachment mount in a closed position in accordance with an embodiment of the present invention; and

FIG. 9 is a perspective view of a pickup truck bed having rails for use in accordance with an embodiment of the present invention.

An embodiment will be described with reference to the accompanying drawings. Corresponding reference characters indicate corresponding parts throughout the several views. The description as set out herein illustrates an arrangement of an embodiment of the present disclosure and is not to be construed as limiting its scope in any manner.

### DESCRIPTION OF THE INVENTION

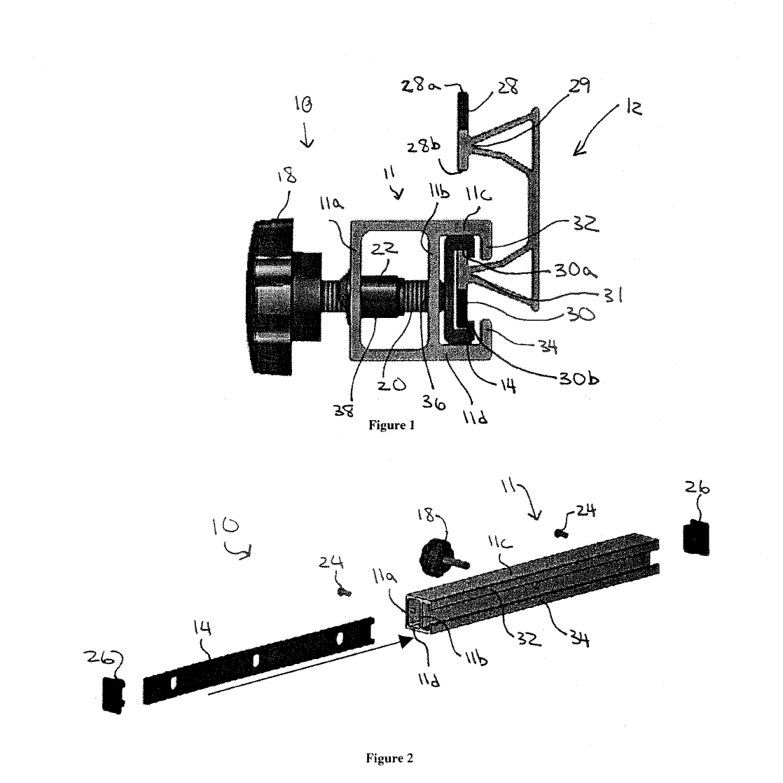

FIG. 1 shows a mount 10 in an attached configuration. The mount 10 is shown as being attached to a rail 12, which may be a rail that is a part of a vehicle or some other support structure. In an embodiment, the rail 12 is a removable rail that is configured to be attached to a side panel of a pickup truck bed 300, as shown in FIG. 9. In other embodiments, the rail 12 is a permanent fixture of a vehicle and may, for example, be a permanent fixture of a pickup truck bed. The rail 12, whether permanent or removable, may be a fixture on any vehicle or support structure, such as within a cargo compartment of a transport vehicle.

The rail 12 may be of a “T-track” type that has one, two, or several attachment tracks 28, 30 for receiving a mount and extends in a longitudinal direction along an axis perpendicular to the cross-sectional plane shown in FIG. 1. The track 28 is configured to have an upper flange 28a extending upwardly from a rail connection point 29 and a lower flange 28b extending downwardly from the rail connection point 29. Likewise, track 30 is configured to have an upper flange 30a extending upwardly from a rail connection point 31 and a lower flange 30b extending downwardly from the rail connection point 31. Conventional mounts for attachment to such rails typically have slots that are slid longitudinally onto the rail tracks at each of their respective ends. The conventional mount is then slid along the track until it reaches its final location. The mount of the present invention may advantageously be attached to a rail track 28, 30 at any location along its length, increasing ease of use and avoiding the problems discussed above,

With reference to FIGS. 1 and 2, the illustrated mount 10 includes an elongated frame 11, which may have a generally C-shaped cross-section. The length of the frame 11 depends on the particular use and is only limited by available space in the environment it is used. As shown in FIG. 1, the frame 11 may include an outer wall 11a and an inner wall 11b connecting the upper wall 11c and lower wall 11d and providing structural support for the frame 11. The frame 11 further includes an upper flange 32 extending downwardly from the upper wall 11c and a lower flange 34 extending upwardly from the lower wall 11d. The ends of the flanges 32 and 34 are spaced apart and the mount 10 has a general C-shape in this area as illustrated in the Figures. The outer wall 11a has a hole 38 and the inner wall 11b has a hole 36 to allow the passage of a set screw or bolt 20. The set screw 20 may have a knob 18 on an outer end so that it may be turned manually by a user.

The holes 36, 38 may be threaded themselves or a threaded locking nut 22 may be provided to receive and secure the threaded set screw 20. In one embodiment, one or both of the holes 36 and 38 are threaded and the locking nut 22 is used as a secondary fastener to hold the screw 20 in place after being tightened. In another embodiment, the holes 36 and 38 are not threaded and the locking nut 22 is the primary fastener for the screw 20.

A liner 14 is also provided and is dimensioned to fit over an attachment track 28, 30 of the rail 12 and within the track receiving space of the frame 11 defined by the inner wall 11b, the upper wall 11c, the lower wall 11d, the upper flange 32, and the lower flange 34, as shown in FIG. 1. The liner 14 may be made of plastic or other suitable material. The liner 14 extends longitudinally preferably to the extent of the mount 10, but may be configured to be shorter or longer than the mount 10. In some embodiments, it may be desirable to provide two or more liners 14 for insertion between the mount 10 and track.

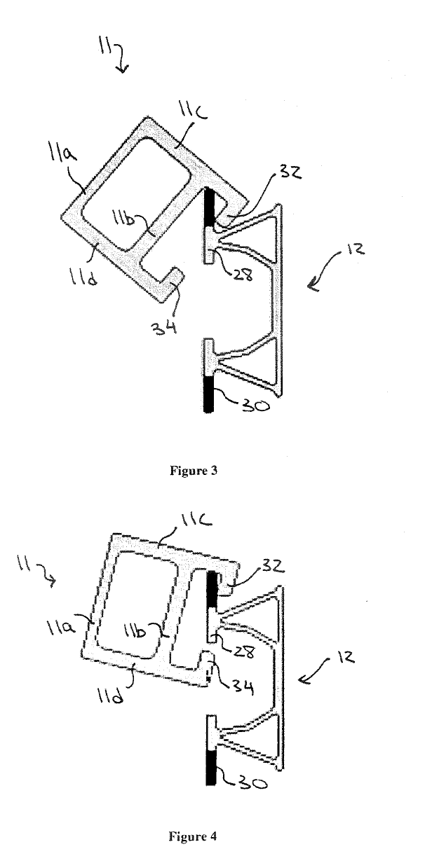

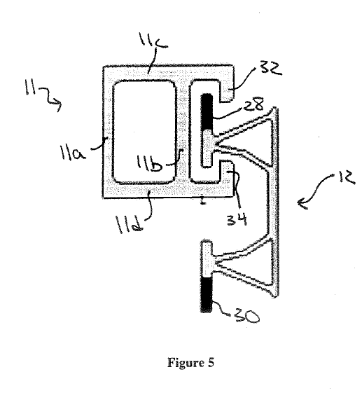

Attachment of the mount 10 to a rail 12 is as follows and is illustrated in FIGS. 2-5. In a first step, shown in FIG. 3, frame 11 is engaged with a rail track 28, with the rail track 28 passing through the opening between the flanges 32 and 34 so that the frame 11 is seated on a top edge of the track 28 generally at the junction of inner wall 11b and upper wall 11c. Then, the frame 11 is rotated or pivoted in a counter-clockwise direction (as shown in FIG. 4; the direction of rotation is only provided for illustration and may be different in different embodiments) so that the lower flange 34 clears and moves past the bottom edge of the track 28 and the frame 11 is generally oriented as shown in FIG. 5. The entire flange of track 28 is now received in the generally C-shaped space of mount 10 through the opening between flanges 32 and 34.

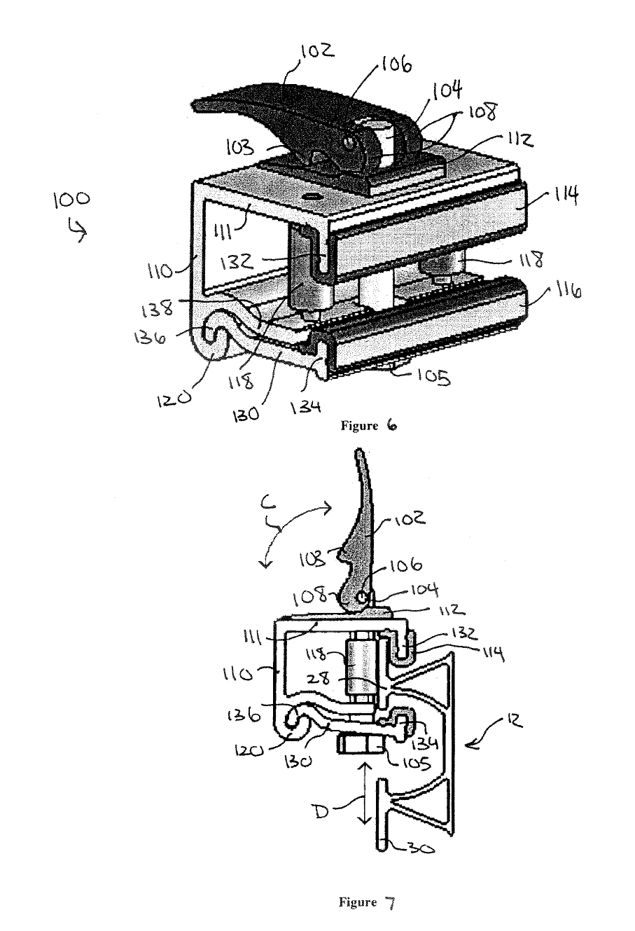

Because the flange of track 28 is smaller than the space in the mount 10 in which it is received, the liner 14 is used to take up excess space and provide a better fit. In the next step, the liner 14 is slid into the cavity between the rail track 28 and the frame 11, as shown in FIGS. 2 and 6. The liner 14 is essentially a spacer to provide a close fit between the frame 11 and the track 28. To slide the liner 14 between the track 28 and the mount 10, an end of the liner 14 is inserted into a space between the mount 10 and the track 28 and is slid in a longitudinal direction of the track 28 and mount 10 until it is fully within the space. The liner 14 is configured to take up the excess clearance between the track 28 and the mount 10, thereby preventing or limiting movement between them. End caps 26 may then be secured to the ends of the frame 11, as shown in FIG. 2, and fastened with end cap fasteners 24. End cap fasteners 24 may be any suitable fastening mechanism, such as screws, bolts, rivets, pins, etc.

Set screw 20 may then be passed through the holes 38 and 36 to abut a portion of the liner 14 to secure the mount 10 on the track 28 or 30 (See FIG. 1). The pressure of the set screw 20 against the liner 14 causes the flanges 32, 34 of the mount 10 to forcibly engage the flanges 28a, 28b of the track 28 (or flanges 30a, 30b of track 30), thereby securing the attachment. While the edges of the liner 14 are present between the flanges 28a, 28b, 32, 34, the engagement may still be considered as between the flanges. As discussed above, the threaded screw 20 may be received by threads in one or both of the holes 36, 38, by a threaded locking nut 22, or both. The set screw 20 may be used to take up any excess clearance in the horizontal direction (as in FIG. 1) so that the mount 10 does not jostle back and forth in the attached configuration. The set screw 20 also limits or prevents movement of the mount 10 in the longitudinal direction (sliding movement along the rail track 28) by imparting a frictional resistance force against the liner 14 in the longitudinal direction.

In accordance with another embodiment of the present invention, the mount 10 may be slid onto one of the tracks 28, 30 at its end and slid longitudinally, rather than attaching at a track location transversely, as described above. Sliding the mount 10 onto a track 28, 30 may be desirable, for example, where truck bed accessories have two mounts that mount to each of the opposite truck bed side panels. In such situations, the mounts may not be able to be articulated as described above to attach to the tracks 28, 30 transversely. After the mounts 10 are slid onto a track 28, 30, the liners 14 may be slid into the cavity between the frame 11 and track 28, 30, as described above. Also, the liners 14 could be slid onto the tracks before sliding on the mounts 10. The knob 18 and set screw 20 may also be utilized as described above to secure the mount 10.

This embodiment addresses the problem of non-parallel rail tracks causing accessories having two mounts to bind as they are slid along the tracks. By forming the mount frame 11 with a relatively large amount of clearance between it and the rail track 28, 30, nonconformities in the tracks do not cause binding and the mounts 10 are allowed to slide easily along the tracks 28, 30 until they reach their desired position. When the mounts 10 are slid to their desired position, the liner 14 may then be inserted into the cavity between the frame 11 and the track 28, 30 to fill the space and create a tight fit. The knob 18 and set screw 20 may be utilized similarly to the embodiment described above to fasten the mount 10 to the track 28, 30.

In accordance with another embodiment of the present invention, FIGS. 6-8 show a transverse attachment of a clamping mount 100 to a rail 12 having tracks 28, 30 that is facilitated by a clamping mechanism. The clamping mechanism generally includes a cam handle 102, a bolt 104, and a floating plate 130. The clamping mount 100 has a similar general structure as the mount 10 shown in FIGS. 1-5 in that it includes an outer wall 110, a lower wall 138, an upper flange 132 extending downwardly from the upper wall 111, and a lower flange 134 extending upwardly from a lower portion of the mount 100.

In an embodiment, the floating plate 130 carries the lower flange 134 which, together with the upper flange 132, engages a rail track 28 for attachment. The plate 130 may be rotatably supported by a lip 120 at a lower portion of the outer wall 110 and have corresponding lip structure 136 that engages with the lip 120 to provide rotational freedom of movement. The plate 130 may be further supported by bolt head 105 (which, in some embodiments, may instead be a locking nut or other similar structure). As is illustrated, lip 120 is curved upwardly, and lip 136 is curved downwardly; and these are interengaged with the end of each received in the concavity defined by the other. The clamping mount 100 further includes rollers 118 for sliding engagement with a rail track 28, 30. One of skill in the art will appreciate that bumpers, a wall, or any other abutment structure may be used in place of the rollers 118 in order to provide adequate support for engagement with a track 28, 30.

Clamping action is enabled by the handle 102, bolt 104, and pad 112. The bolt 104 is operably connected with the handle 102 by a pin 106 and passes through a bore through the pad 112, the upper wall 111, the lower wall 138, and the floating plate 130. The bolt 104 is configured to move along its longitudinal axis (in an “axial” direction, see arrow D in FIG. 7). The handle 102 controls the movement of the bolt 104 by virtue of cam surfaces 108 along the curved portion of the handle 102 that engages with the pad 112, and the eccentric location of pin 106 relative to the curvature of the cam surfaces 108.

Accordingly, when the handle 102 is moved to an open position, as shown in FIG. 7, the pin 106 and therefore the bolt 104 are allowed to slide to a lower position relative to the upper wall 111. This is due to the smaller thickness of the handle cam 108 between the pin 106 and the pad 112 when the handle 102 is in the open position. The handle 102 is moved to the open position prior to the insertion of track 28, 30 into the mount 100 or when the mount 100 is detached from the track 28, 30. The mount 100 is configured so that, when the handle 102 is in the open configuration, there is enough distance between the upper 132 and lower 134 mount flanges so that the track flanges 28a and 28b (or 30a and 30b) may be received therein.

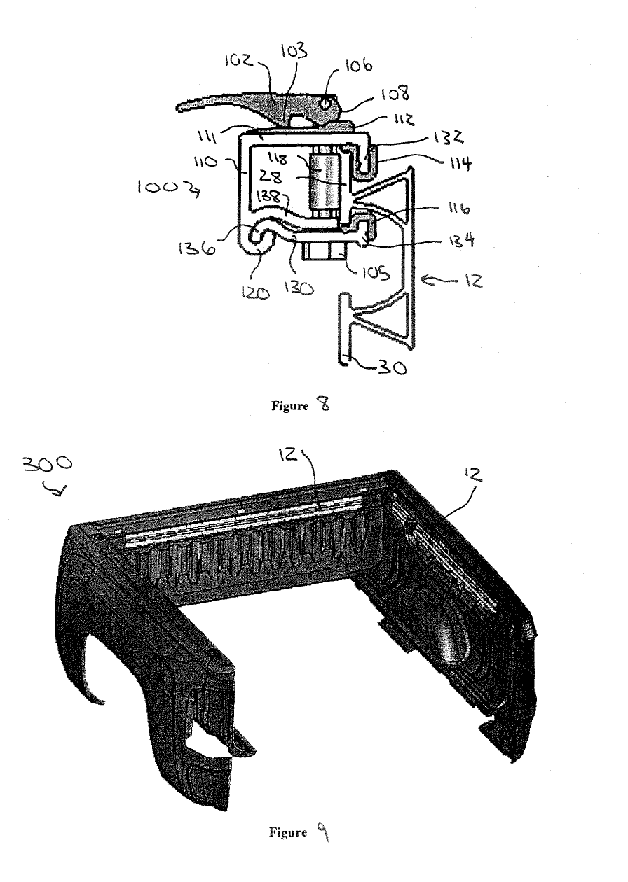

When the handle 102 is rotated in the direction of arrow C to the closed position, shown in FIGS. 6 and 8, the thicker part of the cam 108 is rotated into position between the pin 106 and the pad 112 such that the bolt 104 is urged upward relative to the upper wall 111. The bolt 104, in turn, creates an upward tightening force against the floating plate 130 and the lower flange 134 so that they forcibly engage the flanges 28a, 28b of the track 28, thereby fastening the mount 100 as shown in FIG. 8.

To retain the handle 102 in the closed position, the cam surface 108 may be configured to enable over center action. In this configuration, the eccentric location of the pin 106 is such that the downward tensile force of the bolt 104 created by the forcible engagement with the track 28 acts to pull and maintain the handle 102 in the closed position (FIG. 8) once the thickest part of the cam surface 108 moves past the axis of the bolt.

In an alternative embodiment, the handle 102 may comprise a catch 103 that engages with a lip or some other structure (not shown) on the pad 112 so that a snap-in type fitting is established. Other alternatives for maintaining the handle 102 in the closed position may be used or the clamping mechanism may be designed such that retention structure is unnecessary. Another possible retention mechanism is to form a generally flat surface along the portion of the cam surface 108 that engages the pad 112 when the handle 102 is in the closed position. Such a flat surface may act as a “rest position” such that a greater force would be necessary to move the handle 102 out of the rest position, similar to the concept of the over center action described above.

FIG. 7 shows the clamping mount 100 in an “open” configuration prior to attachment to a track 28. As shown, the handle 102 is oriented in a vertical, open position, as described above. In the open position, the bolt 104 is in a lower position relative to the upper wall 111, which consequently allows the floating plate 130 to rotate downwardly such that the lower flange 134 moves further apart from the upper flange 132. The lower flange 134 and upper flange 132 may be overlaid with a lower insert 116 and an upper insert 114, respectively, made of a relatively softer material than the flanges 132, 134, such as plastic or rubber. The inserts 114, 116 may allow for a tight attachment of the mount 100 by deforming and absorbing the compressive forces. The inserts 114, 116 further act as protective devices to reduce wear on the flange portions 132, 134 and/or the track 28, 30.

In FIG. 8, the mount 100 is shown in the closed, attached position. In this configuration, the mount 100 is clamped onto the track 28 so that a strong fit established and is capable of supporting loads placed onto the mount, such as accessories.

It should be understood that any directional references (e.g., up, down, top, bottom, left, right, etc.) have been used for convenience and with reference to the accompanying Figures. These should not be regarded as limiting. The invention and/or any embodiment thereof may be practiced in various orientations, and no particular directions are essential.

While specific embodiments have been described above, it will be appreciated that the subject of the present disclosure may be practiced otherwise than as described. The descriptions above are intended to be illustrative, not limiting. Thus, it will be apparent to one skilled in the art that modifications may be made without departing from the scope of the claims set out below.

What is claimed is:

1. A method for attaching a mount to an elongated rail, the rail comprising a track with a pair of flanges and the mount comprising a track receiving cavity and a pair of flanges defining an opening to the cavity, the method comprising:
inserting a first of the flanges of the track into the track receiving cavity of the mount through the opening;
pivoting the mount so as to insert a second of the flanges of the track into the track receiving cavity of the mount through the opening; and
fastening the mount to the rail such that a tightened, secure attachment is established with the flanges of the mount being forcibly engaged with the flanges of the track.

2. The method of claim 1, further comprising sliding a liner into a space between the mount and the rail.

3. The method of claim 2, wherein the liner is slid into the space in a longitudinal direction with respect to the length of the rail.

4. The method of claim 3, wherein the mount is fastened to the rail by a set screw that imparts a force against the liner.

5. The method of claim 2, further comprising attaching end caps to at least one end of the mount.

6. The method of claim 1, wherein the mount is fastened to the rail by a set screw.

7. The method of claim 1, wherein the mount is fastened to the rail by a clamping mechanism.

8. A rail attachment mount for mounting to a rail member, the rail member comprising a track with a pair of flanges, the mount comprising:
a body comprising walls defining a track receiving cavity;
a pair of flanges defining an opening to the track receiving cavity;
wherein the track receiving cavity is configured to receive a first of the flanges of the rail member's track through the opening and to enable pivotal movement of the mount to insert a second of the flanges of the rail member's track into the opening of the cavity, and
a fastener constructed to secure the mount onto the track with the flanges of the mount being forcibly engaged with the flanges of the track.

9. The rail attachment mount of claim 8, wherein the fastener comprises a set screw.

10. The rail attachment mount of claim 8, further comprising a liner configured to slide into a space between the rail attachment mount and the track.

11. The rail attachment mount of claim 10, wherein the rail attachment mount further comprises end caps to prevent the liner from slipping out of the mount.

12. The rail attachment mount of claim 8, wherein the fastener comprises a clamping mechanism.

13. The rail attachment mount of claim 12, wherein the clamping mechanism comprises a floating plate, the floating plate being urged in a closing direction when the mount is fastened to the track.

14. The rail attachment mount of claim 13, wherein the mount has a lip portion that engages with a corresponding lip portion on the floating plate to form a rotating joint.

15. The rail attachment mount of claim 12, wherein the clamping mechanism comprises a handle and a bolt, and wherein rotation of the handle moves the bolt in an axial direction, the movement of the bolt acting to fasten the mount to the track.

16. The rail attachment mount of claim 12, wherein inserts are disposed on portions of each of the flanges of the mount.
